(19) United States
(12) Patent Application Publication
(10) Pub. No.: US 2021/0110712 A1
(43) Pub. Date: Apr. 15, 2021

(54) DEVICE FOR DETECTING ROAD SURFACE WATER

(71) Applicant: SAS NEXIALISTE NORMAND, Oissel (FR)

(72) Inventor: Franck Hubert Andre PROUX, Oissel (FR)

(21) Appl. No.: 16/498,388

(22) PCT Filed: Apr. 10, 2018
(86) PCT No.: PCT/EP2018/025105

§ 371 Date: Sep. 27, 2019

(30) Foreign Application Priority Data
Apr. 11, 2017 (RO) A 2017 00216

(51) Int. Cl. G08G 1/01; G08G 1/04; G08G 1/09; G08G 1/07; G01V 8/12; G01V 8/14; G01V 8/20

(52) U.S. Cl. CPC G08G 1/0141; G08G 1/0112; G08G 1/0116; G08G 1/04; G01V 8/20; G08G 1/07; G01V 8/12; G01V 8/14; G08G 1/091

(57) ABSTRACT

The present invention is a device for detecting water on the road that allows to automatically adapt the speed limits on roads according to the traffic conditions, and to transmit the information to a receiver.

The device according to the invention is based on the use of a ray of light transformed by refraction and absorption phenomena for detecting water on the road, by using the passage of vehicles as an indicator of the state of the road by that the wheels will cause in the back of their passage splashes or columns of water when the road is wet, these splashes causing, especially by refraction or absorption effect, a change in the quality of a ray of light when it passes through them before it reaches a receiver.

The receiver can display the information on a vehicle dashboard or on variable display signaling panels, or even transmit it to one or more automatic radar traps.

The present invention is a device that allows automatically adapting the authorized speed limits on the road according to traffic conditions and transmitting information to a receiver. In particular, the receiver can display the information on a vehicle dashboard or on variable display signaling panels, or even transmit it to one or more automatic radar traps.

The invention also relates to a device for detecting water on the road, in particular by the use of a light beam transformed by refraction and absorption phenomena. According to an embodiment of the invention, the device is installed on the road; according to another embodiment, it is mounted on a vehicle.

In rainy weather, traffic conditions are impaired. The rain hinders the driver's vision, and the pavement turned damp or even wet, by reducing the grip of the wheels, increases the braking distance and can even lead to a loss of vehicle control. For these safety reasons, the Highway Code provides for a reduction in speed limits authorized in rainy weather. In France, for example, the speed limit is reduced from 130 km/h to 110 km/h on motorways, from 110 km/h to 100 km/h on fast roads, from 90 km/h to 80 km/h on the roads outside the localities.

But even now, the notion of “rainy weather” is very vague and cannot be appreciated by the control agent alone. At the risk of invalidating the procedure, an automatic speed control of the type fixed-radar trap cannot appreciate this “rainy weather”. A few drops of rain are not enough to characterize it, whereas the rain stopping a few minutes earlier, but leaving a wet pavement will meet this criterion. This is why studies based on pluviometry, hygrometry of the air or the pavements, for example, have not been successful.

Patent application DE3023444A1 states that infrared detection systems are used to determine road surface conditions and are capable of determining the difference between snow, ice and dry or wet, etc. An infrared beam emitter is mounted on a cross-piece overlooking the road surface from a central pillar. A sensor is used to detect the direct reflection from the surface, one for the incident light and one for monitoring the surface temperature. An ambient temperature sensor is coupled to the processing unit.

The outputs from the reflector are compared with reference values in order to identify the different conditions of the road surface.

The device according to the invention is based on the use of a ray of light transformed by refraction and absorption phenomena for the detection of water on the road.

The vehicle is used as a witness of this rainy weather. Practically, the wheels of a vehicle passing on a damp pavement generate splashes behind them. This water column can only be produced if the pavement is really wet and not just damp as in the case of condensation. Its existence is an undisputed proof of the concept of “rainy weather” and cannot be challenged by the courts. Its detection allows automation of authorized maximum speed reduction on fixed, non-human radar traps. Because of its lack of sensitivity, this criterion helps the driver because small rainfalls will not be detected. There is therefore no possibility of false positive results, and the offender will not be able to claim a system error. Moreover, the legislator will have the freedom to adjust the sensitivity of the device to consider only more or less important water columns.

Moreover, and regardless of any regulatory concept, it is essential for a vehicle to know the state of the road and especially if it is wet, for obvious safety reasons. There are adhesion sensors that detect the loss of adhesion, but there is nothing to predict possible loss of adhesion before it occurs, and especially in the case of wet road. The device according to the invention can make it possible to predict this loss of adhesion.

If autonomous vehicles do not provide evidence that they comply with the Highway Code in all circumstances, they cannot be approved. The device according to the invention allows providing a solution to the problem of respecting the speed limits in all circumstances.

The device according to the invention uses the movement of the wheels that lift behind them, when the road is wet, splashes or even water columns.

Splashes, columns, consist of more or less large drops of water and in more or less abundant quantity. A beam of light, whether visible or not, passing through them will suffer, depending on its wavelength, several phenomena that can be cumulated. These are the phenomena of refraction and absorption.

In the following description, the light beam refers to any type of focused electromagnetic beam, for example of the laser type or using an LED-lens system or any other system well known to those skilled in the art.

According to one embodiment, the device for the detection of water on the road uses a light beam and is installed on the road. According to this embodiment, a focused light beam is emitted by a light emitter from one side of the road and received by a sensitive surface on the other side that serves as a light receiver. The beam of light passes a few centimeters above the pavement to be able to intercept the possible splashes immediately behind the wheels. In the case of placing the emitter and also the receiver on the same side of the pavement, a reflector system consisting of a simple mirror or a retro-reflector may be disposed on the other side of the pavement to return the beam from the emitter to the receiver.

In dry weather, the light beam will suddenly be interrupted by the lateral sides of the wheels, and then its passage is again suddenly possible as well. The microprocessor connected to the sensitive surface of the receiver will record the data received by it and will virtually construct a curve in a coordinate system that has time on the abscissa and the intensity of the received electrical signal or the amount of illuminated pixels on the ordinate. The curve thus obtained will be of the “square” type.

In a sufficiently damp time to generate splashes, the light beam will suddenly be interrupted by the lateral sides of the wheels, and then its transmission will gradually return to normal. The signal received by the receiver and transmitted to the microprocessor to obtain the same type of curve will be different immediately after the light beam is blocked by the wheels and will return to its original intensity a few moments later only. This difference is therefore a reliable and objective witness regarding the existence of a wet road and hence of a “rainy weather”.

It is possible to use two main types of measurement on the receiver, namely the intensity of the electromagnetic energy (number of photons) received on a precise area of the receiver using a photovoltaic cell or the light beam receiving surface using a plurality of photovoltaic cells (CCD type, for example) then forming a configuration in pixels. In the first case, the refraction phenomena generate changes in the direction of the light beam. This dispersion causes a decrease in the received signal intensity on the normal reception area of this light beam. The phenomena of absorption of certain wave frequencies, particularly in the infrared, characteristic of water molecules, also cause a decrease in this intensity. A receptor sensitive specifically to water molecule absorption frequencies (wavelength about 2 μm or 10 μm in particular) will increase the device's specificity. In another receiver configuration, it is possible to measure the surface of the spot produced by the light beam on the sensitive surface of the receiver by counting the number of illuminated pixels. The refraction phenomena will lead to the formation of a halo around the normal spot. The surface of this halo will be proportional to the size of the water column crossed by the light beam.

The device can be connected directly to one or more mobile radar traps and send a signal indicating “rainy weather” to them by wire, radio or other type of link, so that they can adjust accordingly.

In order to avoid accidental false positives, such as an accidentally placed water puddle or sand that can interfere with the passage of the beam, and for energy-saving reasons, it is possible to couple this light beam on a hygrometer. Only detecting a relative humidity compatible with a potential “rainy weather” will light the light beam and the signal detection and signal processing systems. The hygrometer may be of the atmospheric or surface type, therefore in contact with the pavement. It can be seen that dust and sand create a turbulent phenomenon in front of and behind the wheels, as opposed to water. The signal is therefore different before the wheel passes and can be easily discernable from the water. It is also possible to multiply the devices near the fixed radar trap to ensure that the pavement is wet entirely and not at a certain point. The regulator may also want to take more “rainy weather” signals over a set time frame to declare “rainy weather.”

In order to limit the parasitic rays of daylight or car headlights, the light receiver is placed at the bottom of a tube, opaque at the wavelengths used, and perpendicular to its axis. The diameter and length of the tube are designed to allow the light beam, normal or degraded, to reach the receiver, but to limit the parasitic rays not coming from the emitter. The inside of the tube is covered with a substance that absorbs unwanted rays in order to prevent their reflections at the bottom of the tube, for example matte black when using wavelengths in the visible spectrum. The tube is, of course, directed exactly to the emitter so that the beam reaches the receiver. In order to increase the reliability of the device, the light beam is emitted with a frequency modulation and amplitude known by a single receiver (pattern), in order to be able to discriminate parasitic rays. This pattern also allows for the avoidance of parasitic rays processing.

It should be noted that the device is insensitive to the emission impairments of the light beam (dirt, drop in emission intensity for example), because what characterizes the wet road is not a global decrease in the received signal but a very precise change in the shape of the curve immediately after wheel passage. Irrespective of the absolute value of the intensity received by the receiver before this passage, the measured value serves as a reference and is recovered immediately (dry road) or for some time (wet road) after the wheel passes. The gradual decrease of this absolute value will, on the contrary, require a repair of the device (cleaning of the elements, quality control of the emitter, etc.)

The emitted light beam must be focused so that the energy reaching the receiver is sufficient and limits any possible harmful effect on the environment. The light beam may be in a visible or invisible radiation spectrum. Although focusing by a lens system can be used, the laser is the most appropriate beam. An infrared laser will probably be preferred because it does not adversely affect the driver and is readily available and inexpensive.

According to another embodiment of the invention, the device for detecting water on the road by using a light beam is fixed to the vehicle.

In a first configuration, the light beam emitter is disposed on one side of the wheel and the receiver on the other side, the two parts being fixed directly under the vehicle, for example, immediately behind the wheel at the level of a flap, for example, or in the wing, at the level of the wheel arch of the mudguard.

The receiver consists of a sensitive surface and a microprocessor that interprets the data transmitted by the sensitive surface. The sensitive surface may consist of one or several photoreceptors, such as photovoltaic cells spread over a small area. The light beam is directed exactly to the receiver and the light beam diameter is at least equal to the diameter of the receiver's sensitive surface. This type of receiver will record the signal strength generated by the photoreceptors. When the light beam crosses a water projection zone, by refraction and absorption phenomena, the light beam will have some of its photons deviated or absorbed, and these will therefore no longer reach the sensitive surface of the receiver. On a dry road, the receiver therefore records a maximum nominal intensity, which will drop on a wet road. When the receiver is made up of several photoreceptors placed on a surface whose diameter is much greater than that of the light beam, the device will record the amount of photoreceptors excited by the light beam. On a dry road or when the vehicle is stationary, the light beam is intense and focused, and the nominal amount of excited photoreceptors is minimal. When the light beam crosses a water projection zone, the refraction phenomena will deflect part of its photons. The diameter of the light beam will then increase, thus exciting more photoreceptors. The signal recorded on this type of receiver is now increasing in rainy weather.

In another configuration, the light beam emitter is now fixed under the vehicle and it is directed to the ground behind the wheels.

The light receiver may be a camera attached under the vehicle recording the image formed by the beam on the ground. This camera consists of a receiving surface comprising one or more photoelectric sensors (photo diode) and an optical system that focuses the image on the sensitive surface. In the case of droplets of water along the beam path, the image will be altered. The image is then processed by a microprocessor, for example, using image processing algorithms, which will in particular seek to highlight changes in clarity, shape, surface, and light intensity of the image. This change will depend on the amount of water projected. The refraction will cause an increase in the image area or its displacement due to the refraction phenomena in relation to the reference image recorded on a dry road or when the vehicle is stationary. An absorption phenomenon if the light beam wavelength corresponds to a water absorption band will cause a decrease in the luminous intensity of the recorded image. In order to increase the reliability of the device, the light beam is emitted with a frequency modulation and an amplitude recognized by a single receiver (pattern), in order to differentiate the parasitic signals. This pattern makes it possible to avoid interfering image processing. To form the reference image, it is possible to record it every time the vehicle is stationary. In reality there are dirt problems on the camera lens and on the light emitter. The image that serves as a reference varies with time and weather conditions due to this dirt. Optionally, a device for cleaning these sensitive surfaces is provided, for example by using “self-cleaning” quality materials and/or pressurized spraying devices or blades of windscreen wiper type or other devices well known to those skilled in the art.

The road being very heterogeneous, another configuration uses two light beams coming from two emitters or from one whose primary light beam is divided by an optical device composed, for example, of mirrors and prisms, in two identical secondary beams. A beam is directed behind the wheel to highlight any splashes, while the other is directed at a distance rather than laterally to the wheel or in front of the reference track of the wheel. In this situation, two images recorded by one or two cameras are formed. It is noted that on a dry road or at a standstill, the two images are virtually identical. When the vehicle is in motion and its wheels raise water droplets from the wet road, the two images are different, depending on the amount of water projected by the wheels. This differentiation indicates the wet road state.

The device may also be complemented by a radio transmitter transmitting the “rainy weather” signal to one or more stationary receivers located on the route or mobile receivers fixed to other unequipped vehicles to inform the other vehicles directly or through panels that display variable messages about “rainy weather” conditions.

The accompanying drawings illustrate the invention:

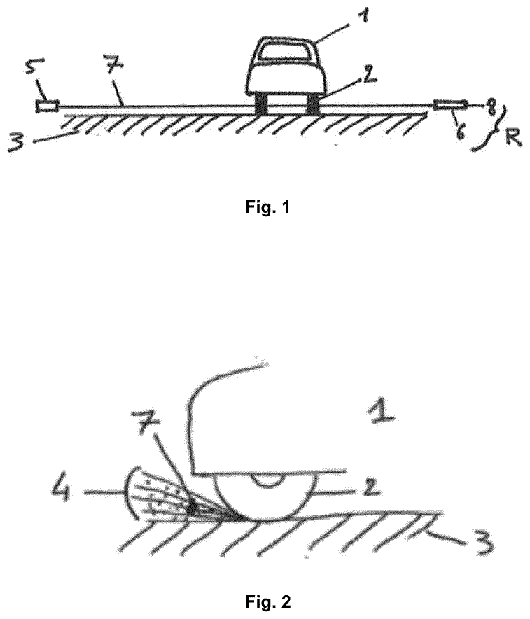

FIG. 1 shows a front view of a fixed device in position

FIG. 2 illustrates a profile view showing the column of water behind the wheels

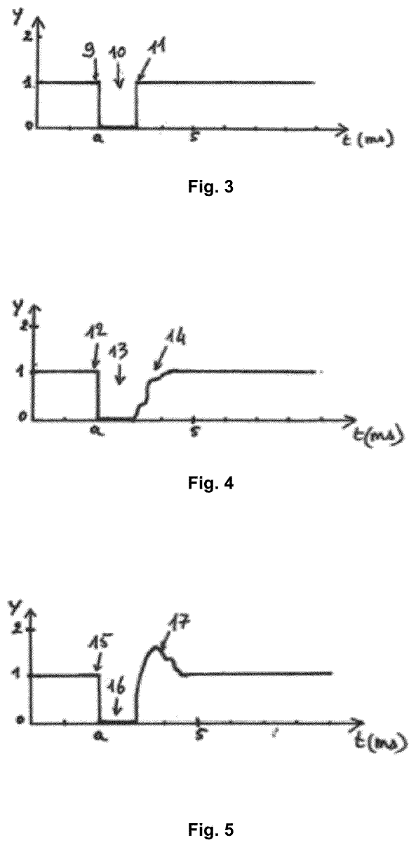

FIG. 3 shows the characteristic curve of a dry road

FIG. 4 shows the characteristic curve of a wet road for intensity measurement.

FIG. 5 shows the characteristic curve of a wet road for a spot surface measurement.

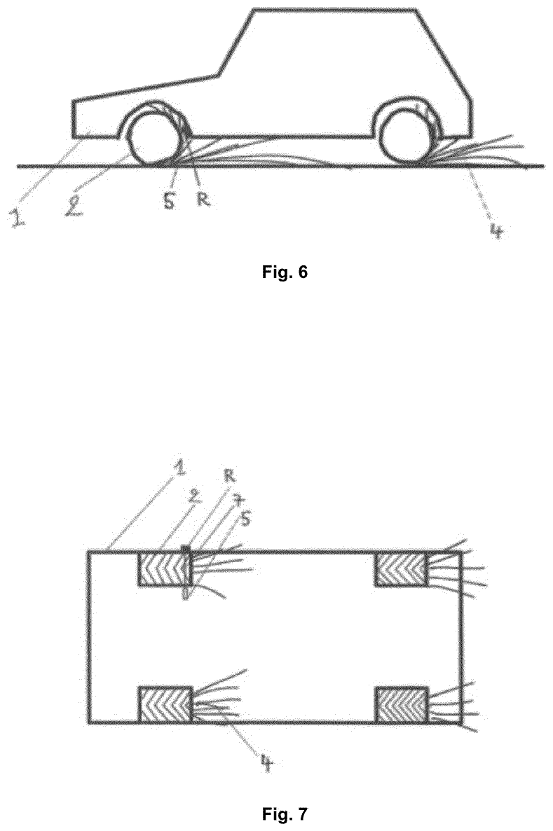

FIG. 6: illustrates the profile view of a vehicle with the light beam emitter arranged on one side of the wheel and the receiver on the other side

FIG. 7: illustrates the vehicle seen from below with the light beam emitter arranged on one side of the wheel and the receiver on the other side

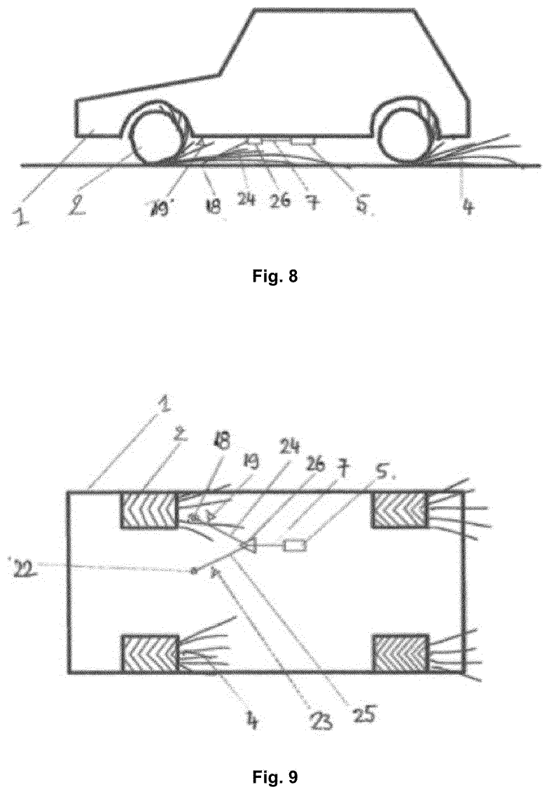

FIG. 8: illustrates the profile view of a vehicle with the device fixed under the vehicle with an emitter and two cameras

FIG. 9 shows the vehicle seen from below with the device fixed under the vehicle with an emitter and two cameras

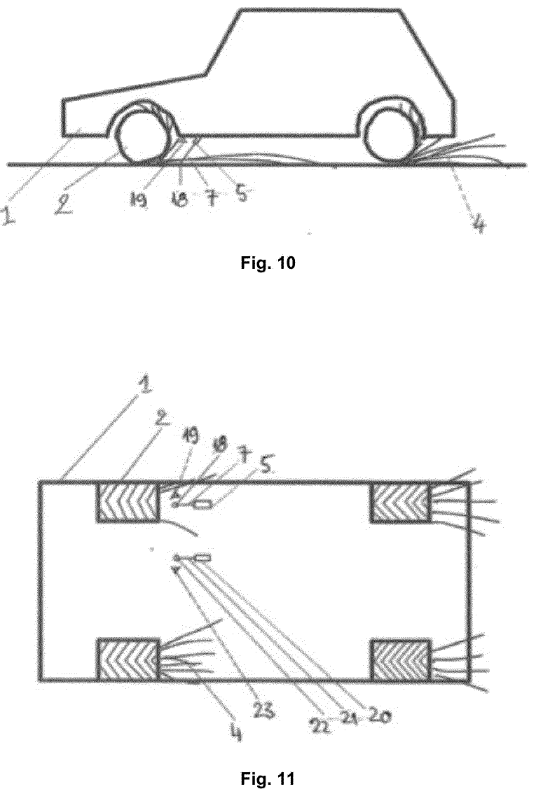

FIG. 10: illustrates the profile view of a vehicle with the device fixed under the vehicle with two emitters and two cameras

FIG. 11: shows the vehicle seen from below with the device fixed under the vehicle with two emitters and two cameras.

With reference to these drawings

FIG. 1 shows a view of a device in position with vehicle (1) from the front, perpendicular to the light beam (7) with its wheels (2) on the road (3), the light beam (7) passing at a height of several centimeters above the road (3) and parallel to its surface. The height is set so that the light beam (7) passes below the bottom of the vehicle bodywork and under the mudguards and is not obstructed by surface defects of the road surface. The light beam (7) emitted by the emitter (5), passes over the road (3), then passes through the tube (6) in its length and reaches the sensitive surface (8) of the receiver (R).

FIG. 2 shows a profile view of the light beam (7) passing through the water column (4) produced by the movement of the wheel (2).

The receiver (R) consists of an opaque tube (6) at the bottom of which a sensitive surface (8) is placed perpendicular to the axis of the tube (6). The tube (6) may for example be made of opaque plastic of PVC type, the inner wall of which is covered with a substance that prevents reflection of parasitic rays not parallel to the axis of the tube (6), for example, a matte black paint. The diameter and length of this tube (6) are defined by those skilled in the art so as to limit parasitic rays. The sensitive surface (8) consists of a photovoltaic system, for example made of CCD sensors. If the signal intensity measurement is recorded, the sensor functions as a photovoltaic cell that will convert the amount of photons received in the normal target area of the light beam (7) on the sensitive surface (8) into an electrical signal whose intensity is proportional to the amount of photons received. When measuring the size of the surface of the spot produced by the light beam (7) on the sensitive surface (8), the receiver consists of several sensors, for example of CCD type, forming pixels. The amount of pixels activated by the light beam (7) is proportional to the spot surface and therefore makes it possible to find out the surface of the spot. These electrical signals are further processed by a microprocessor and a “rainy weather” signal is transmitted by wire or by means of electromagnetic waves to a fixed radar trap, which will then adjusts its maximum authorized limit.

To avoid false positives, especially in the case of an occasional punctual water puddle on the edges close to this system, to avoid too fast aging, and to reduce electrical power consumption, a hygrometer can be connected to this device. The presence of humidity only, in the air (atmospheric hygrometer) or on the road (surface hygrometer), triggers the device to start.

In the case of a dry road, the microprocessor will build a square type signal (FIG. 3) when a wheel passes in front of the light beam (7). On the ordinate axis, the amount of electromagnetic energy received or the amount of photoreceptors activated by the light beam (7), and on the abscissa the time in milliseconds, for example. For a vehicle (1) running at 100 km/h, wheels (2) having a diameter of 60 cm and a beam height in relation to the road of 5 cm, for example, the light beam will suddenly be interrupted during about 12 ms. Before and after this interruption with y=0 for 12 ms, y is constant and has a nominal value of 1. The curve will therefore display a straight line y=1 and then a vertical straight line segment (9) x=a, indicator of the beginning of the passage of the wheel (2), then a straight line segment (10) y=0 for 12 ms (passage of the wheel (2) completely blocking the light beam (7)), and then a vertical straight line segment (11) x=a+12, indicator of the end of the passage of the wheel (2), and finally a straight line y=1.

In the case of a wet road, FIG. 4 shows the curve produced when measuring the amount of photons received by the sensitive surface (8) with this intensity on the ordinate and the time on the abscissa. In the same example of the speed of the vehicle (1), the curve will be a straight line y=1, then a straight line segment (12) vertical x=a marking the beginning of the passage of the wheel (2), then a straight line segment (13) y=0 for 12 ms (passage of the wheel (2) completely blocking the light beam (7)), then a segment (14) more or less inclined or with irregular oscillations between y=0 and y=1 for a variable period (marking the existence of microdroplets or droplets of water that prevent the normal passage of the light beam (7) through the water column (4), and finally a straight line y=1 when the water column ends.

For a wet road in the same example, FIG. 5 shows the case where the receiver (R) measures the surface of the spot produced by the light beam (7) on the sensitive surface (8), this value being used on the ordinate. The curve now shows the same beginning through a straight line y=1, then a straight line segment (15) vertical x=a marking the beginning of the passage of the wheel (2), then a straight line segment (16) y=0 for 12 ms (the passage of the wheel (2) completely blocking the light beam (7)), then a segment (17) which increases with a rather steep slope to exceed y=1 up to a maximum value max (the surface of the spot is larger as a result of the refraction phenomena of the light beam (7) that passes through the water column (4)), and then returns over a variable period with a regular shape or showing irregular oscillations between y=max and y=1, and finally a straight line y=1 when the water column ends.

Observing these non-vertical segments (14) or (17) non-vertical, different from (11) x=a+12 is an incontestable proof of the “rainy weather”. The microprocessor then sends the appropriate signal to the fixed radar trap to adjust its authorized speed limit to that which is defined by the Highway Code in case of “rainy weather”.

In a device fixed on one side of the wheel and the receiver on the other side, directly beneath the vehicle, a light beam emitter (5) is fixed under the vehicle (1) behind the wheel (2), for example in the wheel arch at the wing plane on one side of the wheel (2). It is possible to use one or more wheels (2). A receiver (R) consisting of photoreceptors, such as photovoltaic cells receiving the light beam (7), and a microprocessor that converts the data produced by the sensitive surface, is mounted on the other side of the wheel. The emitter (5) sends a light beam (7) having an electromagnetic pattern emitted by a frequency modulation and amplitude known by a single receiver (pattern), in order to be able to differentiate the interfering signals. This pattern helps to avoid processing the parasitic lights on the receiver (R), and thus to limit interference phenomena. On a dry road or when the vehicle (1) is stationary, the receiver (R) records a signal with a nominal intensity on the receiving surface, or a nominal surface when the receiver is expected to record the surface excited by the light beam (7). In the case of water splashing (4) by the wheel (2) when the vehicle (1) moves on a wet road, the light beam undergoes transformations by refraction and absorption phenomena. A portion of the photons will be deflected or absorbed and will no longer reach the target, so decreasing in this situation the amount of light energy recorded by the receiver (R) on its receiving surface. A decrease in the intensity of the signal received by the receiver (R) is then noted. Deflections caused by the refraction phenomena will cause an increase in the diameter of the light beam (7), and hence an increase in the amount of excited photoreceptors at the receiver (R) level. In this case, an increase in the signal from this type of receptor is noted. These changes demonstrate the existence of water splashing and, thanks to it, the existence of a wet road on which it is necessary to reduce the speed of the vehicle (1) which risks losing its adhesion.

In a device mounted under the vehicle, the emitter (5) of the light beam (7) is fixed under the vehicle (1). FIGS. 10 and 11 show a system in which a single emitter (5) directs its light beam (7) on the pavement forming an image (18) behind the wheel (2). A camera (19) records the image (18) and sends it to a microprocessor equipped with image processing algorithms, and compares it with a reference image. This reference image is obtained by filming the image (18) obtained when the vehicle (1) is stopped. Without changing the operation at all, the skilled artisan may prefer the architecture with two emitters (5, 20) each producing an identical light beam. FIGS. 8 and 9 show a system with an emitter (5) and two cameras (19, 23) simultaneously shooting the two images (18, 22) produced by the light rays (24, 25) on the pavement. In the example with a single light emitter (5), the primary light beam (7) produces two identical secondary light beams (24, 25) by passing through an optical device (26). It is composed, for example, of a mirror that directs the beam (7) towards the roadway and a prism separating the primary beam (7) into two secondary beams (24, 25). The secondary measuring beam (24) is directed towards the pavement immediately behind the wheel (2). The reference secondary beam (25) is directed towards the pavement laterally to the wheel (2) in order to be more sheltered from the sprinkled columns of water (4) raised by the wheel (2) when the road is wet. A camera (23) records the image (22) of the secondary reference beam (25) on the pavement, while the other camera (19) records the image (18) of the secondary measurement beam (24). The images (18, 22) are then sent to a microprocessor equipped with image processing algorithms that compares them. A difference between the reference image (22) and the measurement image (18) indicates the existence of splashing water columns behind the wheel (2) and highlights the wet state of the road.

Cleaning devices for the lens of the camera or cameras (19, 23) or the receiver (R) and the emitter or emitters (5, 20) are provided in order to limit the dirt that disturbs the transmission of light rays. They consist, for example, of a pressurized sprinkler system or windscreen wiper blades, for example. The use of self-cleaning glasses by depositing a titanium dioxide based photocatalytic layer on them, for example, may also be considered.

The device according to the invention is connected by wire or radio to the computer of the vehicle (2), which can in turn send a warning message to the driver or can directly adjust the speed of the vehicle (2) in view of the deteriorated traffic conditions. The device sends information to the computer.

It translates this information by comparing it with the thresholds set by the government to declare the existence of a “rainy weather”, the presence of rain, wet or glazed pavement, crowding of cars, a peak of pollution, etc.

The computer translates this information into the maximum authorized speed in these damaged conditions and sends this value to a panel or multiple panels for digital display. The panel or panels display in turn for the drivers the maximum speed in these deteriorated conditions.

In the absence of information on deteriorated conditions, the relevant panels and radar traps set at the normal speed limit.

The device according to the invention can be used in a group of detectors for deteriorated traffic conditions connected via a computer to one or more variable display speed limitation panels (LED or LCD type, for example) and whose display is remotely changeable, this or these latter indicating in real time the authorized speed limit adapted to traffic conditions.

The group of detectors for deteriorated traffic conditions comprises one or more detectors arranged within one or more boxes.

The group of detectors for deteriorated traffic conditions consists of all or some of these detection elements centralized within a single detection box or in several systems, and connected to a computer that gathers the information collected by each detection system and sends the signal adapted to the damage observed to the display panels and to the radar traps or to the display panels that in turn transmit the signal to the radar traps.

Without limitation in the composition of the group of detectors for deteriorated traffic conditions, a complete system is composed, for example, of a “rainy weather” detector, a rain detector, a detector of wet or icy road, a detector of the number of vehicles per hour, a detector of decline of visibility, an air pollution detector.

In order to achieve an educational effect and to get the involvement of motorists, it is desirable to show at the same time the reason or reasons for the lowering of the maximum authorized speed, for example, wet road, ice, low visibility, rainy weather, pollution, and crowding of vehicles and so on.

The display panel or panels, after being updated, transmit this value to one or more automatic control radar traps.

The computer can also transmit information to display panels and radar traps simultaneously.

The computer or display panel or radar trap sends the information to a regional or national center to inform the authorities about the real-time traffic status.

The links between the detectors, the computer, the panel, the radar trap and the center are made by a wired system or by electromagnetic waves. The communication system based on the LoRaWAN (Long Range Wide-Area Network) protocol may be applicable very well herein, for example.

The device according to the invention is particularly intended for road safety.

1. A device for detecting water on the road, wherein said device consists of an emitter (5) of a focused light beam (7), a receiver (R), a device which allows processing of the signal received by the receiver (R) when the latter receives the beam (7), by using the passage of the vehicles (1) as an indicator of the state of the road (3) by that the wheels (2) will cause in the back of their passage splashes or water columns (4) when the road (3) is wet, these splashes (4) causing, especially by refraction or absorption effect, a change in the quality of the light beam (7) when the latter passes through them before it reaches the receiver (R).

2. The device according to claim 1, wherein the light beam (7) is emitted with a frequency modulation and amplitude known by a single receiver (pattern).

3. The device according to claim 1, wherein the emitter (5) is positioned on one side of the road (3), the beam (7) passing over it and targeting the receiver (R) on the other side of the road (3), the receiver (R) being directed towards the emitter (5).

4. The device according to claim 1, wherein the emitter (5) and the receiver (R) are positioned on the same side of the road (3), and a reflection system consisting of a simple mirror or a retro-reflector is placed on the other side of the road (3) and returns the ray from the emitter (5) to the receiver (R).

5. The device according to claim 1, wherein said device is installed on a vehicle (1), fixed thereunder.

6. The device according to claim 5, wherein the emitter (5) and the receiver (R) are positioned behind a wheel or wheels (2) on both sides thereof.

7. The device according to claim 5, wherein the emitter (5) is positioned so as to direct a light beam behind the wheel (2) on the pavement, and the receiver (R) of a camera (19) is positioned so as to film the image (18) produced by the light beam on the pavement.

8. The device according to claim 7, wherein said device comprises a second emitter which directs a light beam on the pavement in an area sheltered from splashes to form there an image filmed by a second receiving camera.

9. The device according to claim 7, wherein said device comprises an optical device for separating a primary light beam produced by the single emitter in order to obtain the light beams (24, 25) aimed for forming the images (18, 22).

10. The device according to claim 7, wherein said device comprises means for cleaning the lenses of the camera or cameras (19, 23) or the receiver (R) and the emitter or emitters (5, 20).

11. The device according to claim 7, wherein the device for processing the signal received by the receiver is a microprocessor equipped with image processing algorithms.

12. The device according to claim 3, wherein the receiver (R) consists of a sensitive surface (8) perpendicular to the axis of a tube (6) located in the bottom of the tube (6) whose opacity, diameter, length, as well as inner coating make it possible to limit interfering rays which are not directed parallel to the axis of this tube (6).

13. The device according to claim 12, wherein the sensitive surface (8) consists of a photovoltaic cell which will convert the amount of photons received by the sensitive surface (8) into an electrical signal.

14. The device according to claim 12, wherein the sensitive surface (8) consists of a plurality of photovoltaic sensors constituting pixels and in which counting of the sensors stimulated by the beam (7) makes it possible to measure the surface of the spot of the beam (7) on the face of the sensitive surface (8).

15. The device according to claim 1, wherein said device is connected by wire or radio to variable display signaling panels, to one or more radar traps or to the computer of the vehicle (2) on which it is fixed.

16. The device according to claim 1, wherein the activation of the device is triggered by an atmospheric or surface hygrometer placed on the road (3).

17. The group of detectors for deteriorated traffic conditions comprising the device of the invention according to claim 1.

18. The group of detectors for deteriorated traffic conditions according to claim 17, wherein a wired or radio link with a regional or national monitoring center to inform in real time about the traffic conditions and the maximum authorized speed.

19. The device according to claim 2, wherein the emitter is positioned on one side of the road, the beam passing over it and targeting the receiver on the other side of the road, the receiver being directed towards the emitter.

20. The device according to claim 2, wherein the emitter and the receiver are positioned on the same side of the road, and a reflection system comprising a simple mirror or a retro-reflector is placed on the other side of the road and returns the ray from the emitter to the receiver.
